(19) United States
(12) Patent Application Publication
(10) Pub. No.: US 2012/0087571 A1
(43) Pub. Date: Apr. 12, 2012

(54) METHOD AND APPARATUS FOR SYNCHRONIZING 3-DIMENSIONAL IMAGE

(75) Inventors: Gwang Soon Lee, Daejeon-si (KR); Won Sik Cheong, Daejeon-si (KR); Hyun Lee, Daejeon-si (KR); Kug Jin Yun, Daejeon-si (KR); Bong Ho Lee, Daejeon-si (KR); Nam Ho Hur, Daejeon-si (KR); Soo In Lee, Daejeon-si (KR)

(73) Assignee: Electronics and Telecommunications Research Institute, Daejeon-si (KR)

(21) Appl. No.: 13/269,325

(22) Filed: Oct. 7, 2011

(30) Foreign Application Priority Data
Oct. 8, 2010 (KR) 10-2010-0098140
Jan. 25, 2011 (KR) 10-2011-0007091

(51) Int. Cl. G06K 9/46

(52) U.S. Cl. 382/154

(57) ABSTRACT

There are provided a 3-D image synchronization method and apparatus. The method comprises determining a reference region for each of the frames of a first image and determining a counter region for each of the frames of a second image, corresponding to the reference region, for the first image and the second image forming a 3-D image; calculating the feature values of the reference region and the counter region; extracting a frame difference between the first image and the second image based on the feature values; and moving any one of the first image and the second image in the time domain based on the extracted frame difference.

This application claims the benefit of priority of Korean Patent Application No. 10-2010-0098140 filed on Oct. 8, 2010 and Korean Patent Application No. 10-2011-0007091 filed on Jan. 25, 2011 which are incorporated by reference in its entirety herein.

### BACKGROUND OF THE INVENTION

1. Technical Field

This document relates to a three dimensional (3-D) image system and, more particularly, to a method and apparatus for performing frame synchronization between left and right images forming a 3-D image.

2. Discussion of the Related Art

3-D image broadcasting has recently been in the spotlight. When seeing an image, the left eye and the right eye of a person see different images. The distance is detected and a feeling of stereoscopy is obtained using different pieces of visual information which are obtained by the left and right eyes.

A stereoscopic image is based on the above principle. A stereoscopic image is realized by directly capturing images using a stereoscropic camera or obtaining images to be seen by the left eye and the right eye through computer graphics, etc., combining the images, and then having the two eyes see different images so that a person can feel a feeling of stereoscopy. If left and right images not temporally synchronized with each other are seen by the left eye and the right eye, a person cannot feel a satisfactory cubic effect through the stereoscopic image. It is therefore necessary to automatically check whether the frames of the left image, seen by the left eye of the stereoscopic image, and the frames of the right image seen by the right eye of the stereoscopic image have been correctly synchronized and to correct the frames of the left image and the right image if the frames have not been temporally synchronized.

Frames of left and right images, not properly synchronized, may result in that the frames of a left and right stereoscopic pair are temporally deviated from each other. Asynchronization between the frames of the left and right images as described above may be generated when the stereoscopic image is captured, stored, distributed, transmitted, and played. Accordingly, a user directly checks whether left and right images form a correct stereoscopic pair and edits and corrects the left and right images using a tool for producing and editing a stereoscopic image or a stereoscopic image display device.

A method of directly checking whether left and right images are temporally matched with each other includes a method of directly checking a stereoscopic image being played in a stereoscopic image display device using eyes and of checking whether there is a feeling of stereoscopy and whether the frames of left and right images have been synchronized if the images are awkward. In this conventional method, however, it may be difficult to determine whether the frames of left and right images have been properly synchronized because a criterion for determining whether a feeling of stereoscopy exists or whether the images are awkward is subjective although the images are directly checked by eyes.

Therefore, there is a need for a method and apparatus for checking whether the frames of left and right images have been properly synchronized using features, appearing in a properly synchronized 3-D image when the image is originally generated, and for automatically changing and correcting the frames if synchronization has not been properly performed.

### SUMMARY OF THE INVENTION

An aspect of this document is to provide a method and apparatus capable of performing synchronization between the frames of left and right images, forming a stereoscopic image, in a 3-D stereoscopic image system.

In an aspect, a 3-D image synchronization method according to an aspect of this document comprises determining a reference region for each of the frames of a first image and determining a counter region for each of the frames of a second image, corresponding to the reference region, for the first image and the second image forming a 3-D image; calculating the feature values of the reference region and the counter region; extracting a frame difference between the first image and the second image based on the feature values; and moving any one of the first image and the second image in the time domain based on the extracted frame difference, wherein extracting the frame difference comprises detecting a frame of the second image, having a feature value most similar to each of the frames of the first image, by comparing a feature value of the reference region and a feature value of the counter region.

The feature values may include a motion vector value for the reference region or the counter region.

The first image may be one of a left image and a right image which form the 3-D image, and the second image may be the other of the left image and the right image.

The feature values may include luminance or chrominance for the reference region or the counter region.

Each of the reference region and the counter region may comprise M pixels in an abscissa axis and N pixels in a vertical axis which form each block, from among a plurality of pixels forming a frame (M and N are natural numbers).

The frame difference may be information indicating the number of frames in which the first image and the second image are temporally deviated from each other.

The 3-D image synchronization method may further comprise receiving a first image stream and a second image stream and generating the first image and the second image by decoding the first image stream and the second image stream.

A three dimensional (3-D) image synchronization apparatus according to another aspect of this document comprises a matching region determination unit for determining a reference region for each of the frames of a first image and determining a counter region for each of the frames of a second image, corresponding to the reference region, for the first image and the second image forming a 3-D image; a feature value calculation unit for receiving information about the reference region and the counter region from the matching region determination unit and calculating the feature values of the reference region and the counter region; a frame difference extraction unit for extracting a frame difference between the first image and the second image based on the feature values; and a synchronization unit for moving any one of the first image and the second image in the time domain based on the extracted frame difference, wherein the frame difference extraction unit detects a frame of the second image, having a feature value most similar to each of the frames of the first image, by comparing a feature value of the reference region and a feature value of the counter region.

The feature values may comprise a motion vector value for the reference region or the counter region.

The first image may be one of a left image and a right image which form the 3-D image, and the second image may be the other of the left image and the right image.

The feature values may comprise luminance or chrominance for the reference region or the counter region.

Each of the reference region and the counter region may comprise M pixels in an abscissa axis and N pixels in a vertical axis which form each block, from among a plurality of pixels forming a frame (M and N are natural numbers).

The frame difference may be information indicating the number of frames in which the first image and the second image are temporally deviated from each other.

The 3-D image synchronization apparatus may further comprise a decoding unit for receiving a first image stream and a second image stream and generating the first image and the second image by decoding the first image stream and the second image stream.

The 3-D image synchronization apparatus may further comprise a display for receiving image streams from the synchronization unit and outputting the 3-D image.

### BRIEF DESCRIPTION OF THE DRAWINGS

FIG. 1 shows a first image and a second image which form a 3-D image;

FIG. 2 shows a 3-D image synchronization apparatus according to an embodiment of this document;

FIG. 3 shows an example in which a frame difference extraction unit extracts a difference between frames; and

FIG. 4 is a flowchart illustrating a 3-D image synchronization method according to an embodiment of this document.

### DETAILED DESCRIPTION OF THE INVENTION

The present invention relates to a 3-D image synchronization method and apparatus. A stereoscopic effect of a 3-D image chiefly depends on factors, such as a binocular disparity, convergence, and motion parallax, in terms of somatology. A binocular disparity means that both eyes of a person obtain different pieces of information about the same object. Convergence means an angle formed by the sights of both eyes according to the distance when a person sees an object. In case of a close object, the angle is increased, and in case of a distant object, the angle is decreased. Motion parallax means that the size of an object and a face seen by eyes are different according to relative movement between an object and a person who sees the object.

In terms of technology, a stereoscopic effect of a 3-D image is chiefly realized using a binocular disparity, convergence, and so on. A current 3-D image produces an effect that 3-D stereoscopy looks like being seen using a method of forming two images, seen by the left eye and the right eye of a person, into one 3-D image in order to implement a binocular disparity and of having different images seen by the left and right eyes through polarizing glasses or a time-division method (a 3-D image may be implemented in a display device without auxiliary equipment, such as glasses, according to circumstances).

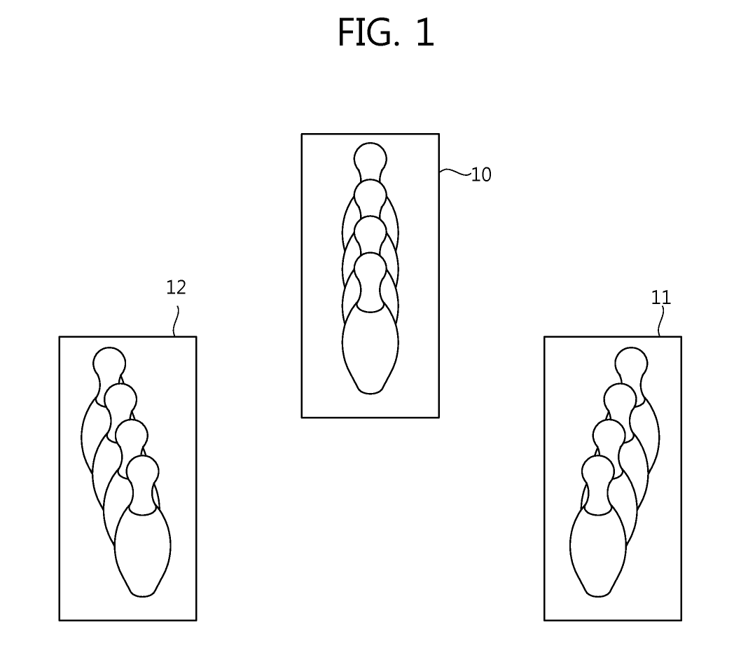

FIG. 1 shows a first image and a second image which form a 3-D image.

Referring to FIG. 1, the first image 11 may be an image seen by the right eye of a person (i.e., a right image), and the second image 12 may be an image seen by the left eye of a person (i.e., a left image) (alternatively, the first image may be the left image and the second image may be the right image). The first image 11 and the second image 12 are temporally synchronized with each other and displayed in the same display device, thus forming one 3-D image 10. Each of the first image 11 and the second image 12 comprises a plurality of frames in terms of time. Each of the first image 11 and the second image 12 may comprise a plurality of frames, such as 30 frames or 60 frames per second. If the first image 11 and the second image 12 are represented by temporally corresponding frame pairs (i.e., synchronization is properly performed), a 3-D image 10 is properly displayed. If synchronization between the first image 11 and the second image 12 is not properly performed, there are problems in that the 3-D image 10 does not produce a satisfactory 3-D effect and makes a viewer visually have a feeling of fatigue.

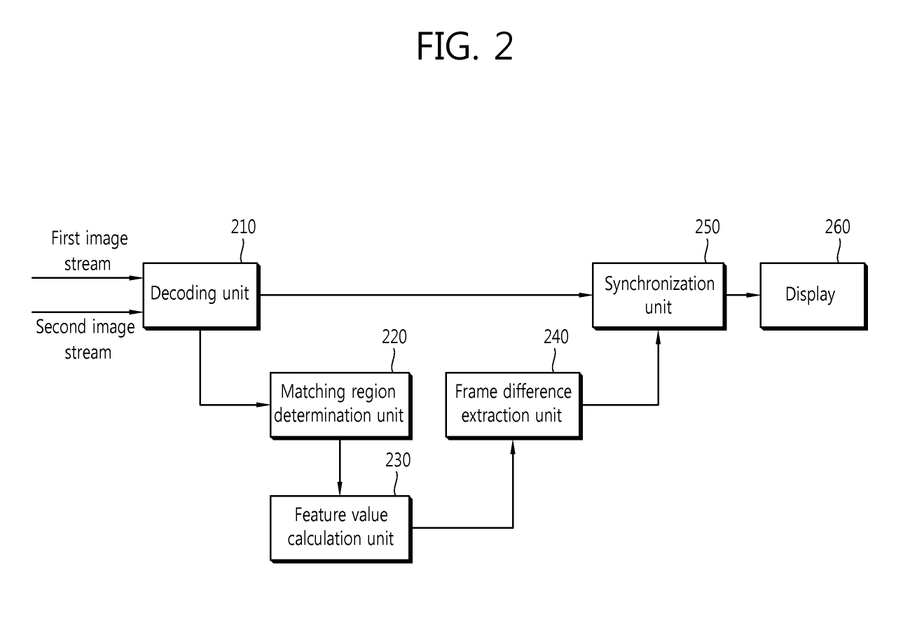

FIG. 2 shows a 3-D image synchronization apparatus according to an embodiment of this document.

Referring to FIG. 2, the synchronization apparatus comprises a decoding unit 210, a matching region determination unit 220, a feature value calculation unit 230, a frame difference extraction unit 240, a synchronization unit 250, and a display 260.

The decoding unit 210 generates a decoded first image and a decoded second image by decoding a first image stream for a first image externally received and a second image stream for a second image externally received. The first image stream and the second image stream may be compression image data streams which are encoded using various methods, such as a motion picture experts group (MPGE) 2, 4, 7, or H.264. The first image stream may be, for example, a left image forming a 3-D image, and the second image stream may be, for example, a right image forming the 3-D image.

The matching region determination unit 220 determines a matching region where the feature values of the decoded first image and the decoded second image, received from the decoding unit 210, will be compared with each other. The matching region is composed of a reference region and a counter region. The reference region is a specific region in the frames of a reference image (e.g., the first image), and the counter region is a specific region of the second image that will be compared with the reference region. The reference region and the counter region have the same number of pixels (or the same area), but may be placed at different positions within a relevant image frame.

The reference region and the counter region may be, for example, a block having an M×N (M is the number of horizontal pixels, N is the number of vertical pixels, and M or N is a natural number) size, some region of an image, such as a circle, a sample pixel selected according to a specific criterion or randomly, a plurality of sample pixels, at least one region of an image, and pixels. For example, the reference region may be pixels within a region having a specific size within a first image frame, and pixels (the pixels are pixels having the highest similarities to pixels within the first image frame) within a second image frame which are considered as counter points for the pixels form a counter region.

The reference region and the counter region may be determined using various and known stereo matching schemes, such as disparity estimation and feature point extraction.

The disparity estimation scheme may be implemented using various matching scheme to which algorithms, such as sum of squared distance (SSD) for analyzing a brightness difference between pixels, sum of absolute distance (SAD) for analyzing a brightness difference between pixels, a normalized correlation coefficient (NCC) for analyzing a correlation and so on, have been applied in calculating similarities between pixels. In the feature point extraction scheme, the matching region is determined by extracting feature points, such as boundaries, corners, and points having suddenly changing colors within an image and checking similarities between the feature points of a first image and a second image, forming a 3-D image, using a random sample consensus (RANSAC) algorithm. In addition to the above schemes, the matching region may be determined using various methods, such as a region in which a disparity value is 0, a region in which the convergences of 3-D cameras cross each other, and the central region of a left image and a right image.

The feature value calculation unit 230 is a module for calculating a feature value for the matching region for every frame in each of the first image and the second image in the time domain. The feature value is a value having a feature of the matching region within the frames of the first image and the second image. The feature value may be, for example, a motion vector (MV), luminance, and chrominance.

If a motion vector is used as the feature value, the feature value calculation unit 230 may calculate the motion vector through the motion estimation or feature point tracking of each frame. If luminance or chrominance is used as the feature value, a value in which a brightness value or a color value in each of pixels is accumulated in a direction where the matching region is projected vertically or horizontally when the matching region is projected.

The feature value calculation unit 230 calculates the feature value of the reference region and the feature value of the counter region and may calculate a distribution of the feature values when a plurality of the matching regions exists.

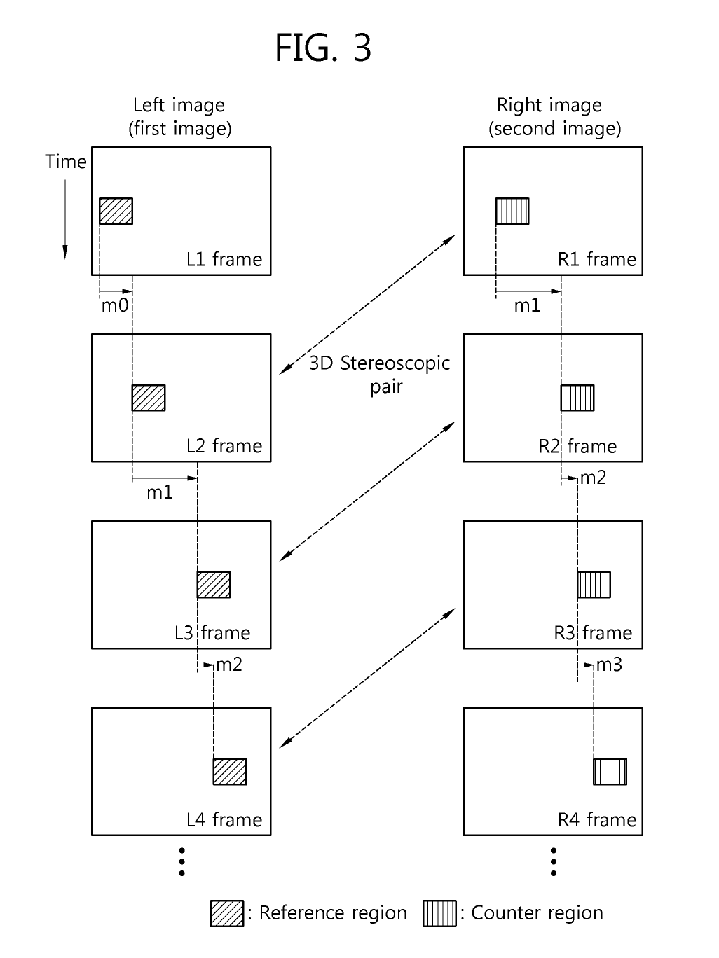

The frame difference extraction unit 240 receives a feature value for the first image frame of the first image and a feature value for the second image frame of the second image from the feature value calculation unit 230 and extracts a temporal difference between the first image frame and the second image frame (i.e., a difference between frames) in such a way as to find an image frame pair having the highest similarities by comparing the similarities of the first image frame and the second image frame with each other. The difference between frames may be given, for example, as a value of a frame unit. A process of the frame difference extraction unit 240 calculating the frame difference will be described in detail with reference to FIG. 3.

The synchronization unit 250 receives the difference between frames and moves the first image or the second image in the time domain forward or backward. For example, the synchronization unit 250 may perform synchronization by delaying one of two images by the frame difference. When the frame difference is 0, correction related to synchronization may not be performed, and a 3-D image may be outputted.

The synchronization unit 250 may activate a function of correcting frame synchronization between the first image and the second image only when a viewer feels unnatural and requests synchronization to be corrected through a user selection function while viewing a 3-D image through the display 260.

The frame difference extraction unit 240 and the synchronization unit 250 may be connected to a 3-D audio/video encoder. That is, the frame difference extraction unit 240 and the synchronization unit 250 may also be applied to a stream remultiplexing process required in the rear of the encoder. Here, the synchronization unit 250 for the left and right image frames may correct time information (e.g., a PCR (program clock reference), a PTS (presentation time stamp), and a CTS (composition time stamp)) about an encoded stream by the amount that one of two images has been delayed.

The display 260 is an apparatus for receiving the first image and the second image for which synchronization has been performed and displaying a 3-D image. The display 260 may be implemented separately from the 3-D synchronization apparatus or may be included in the 3-D synchronization apparatus.

In the above apparatus, processing, such as the determination of the matching region and the calculation of the motion vector (i.e., motion estimation) requires a relatively heavy computational load. For this reason, a frame difference between the left and right images may be calculated in the encoding process of the 3-D encoder, and information about the frame difference may be separately transmitted. In this case, frame synchronization may be performed by directly transmitting the decoded first image and the decoded second image to the synchronization unit 250 without via the frame difference extraction unit 240.

FIG. 3 shows an example in which the frame difference extraction unit 240 extracts a difference between frames.

Referring to FIG. 3, a left image (e.g., a first image) may comprise a plurality of frames in the time domain, and a right image (e.g., a second image) may comprise a plurality of frames in the time domain. For example, assuming that the frames of the first image are L1, L2, L3, and L4 and the frames of the second image are R1, R2, R3, and R4 frame, the matching region determination unit 220 determines a matching region for each of pairs of the frames (L1, R1), (L2, R2), (L3, R3), and (L4, R4). The frame pairs (L1, R1), (L2, R2), (L3, R3), and (L4, R4) may be said to be frame pairs outputted when additional synchronization correction is not performed.

The feature value calculation unit 230 calculates a feature value (e.g., a motion vector) for the matching region of each frame. The frame difference extraction unit 240 extracts a frame pair having the highest correlation of a feature value distribution through comparing the feature values of the frames with each other. For example, the frame difference extraction unit 240 may extract a frame pair having the smallest feature value difference. The calculation of the correlation may be performed using various and known methods, such as cross correlation and cepstrum.

FIG. 3 illustrates the motion vectors as the feature values. If the frame pairs (L2, R1), (L3, R2), (L4, R3) have the most similar motion vectors, the frame pairs are determined as 3-D image frame pairs forming a stereoscopic image. This is because the feature values may have the most similarities in the first image frame and the second image frame which have been accurately synchronized. In the above example, the frame difference extraction unit 240 extracts information about a 1 frame difference and provides the information to the synchronization unit 250. The frame difference extraction unit 240 may obtain the result using a repetitive and statistical method for feature values in several regions in order to accurately extract the frame difference.

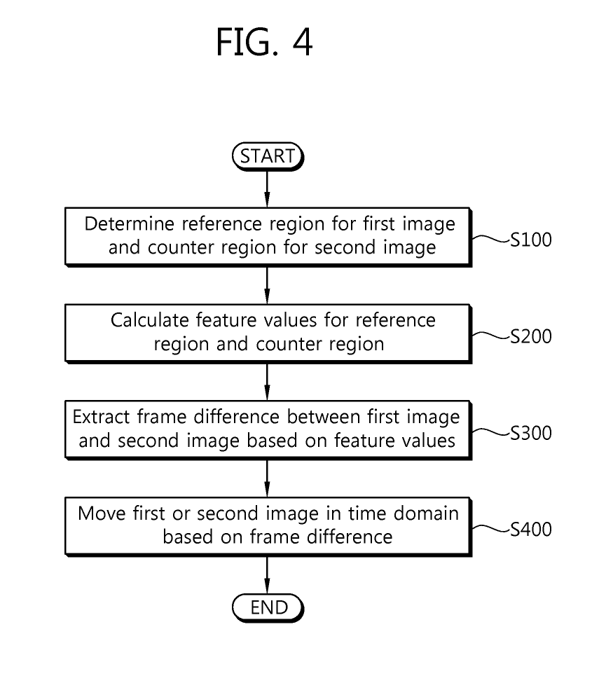

FIG. 4 is a flowchart illustrating a 3-D image synchronization method according to an embodiment of the present invention.

Referring to FIG. 4, in the 3-D image synchronization method, a reference region for each of the frames of a first image, in the first image and a second image forming a 3-D image, is determined, and a counter region for each of the frames of the second image, corresponding to the reference region, is determined at step S100. Here, frame pairs, comprising the frames of the first image and the frames of the second image, are determined in order of input to the decoding unit 210. This process may be performed by the matching region determination unit 220.

The feature values of the reference region and the counter region for each of the frame pairs are determined at step S200. The feature values may be various, such as a motion vector, luminance, and chrominance, as described above. This process may be performed by the feature value calculation unit.

A frame difference between the first image and the second image is extracted on the basis of the feature values at step S300. This process may be performed by the frame difference extraction unit 240.

Any one of the first image and the second image is moved forward or backward in the time domain on the basis of the extracted frame difference at step S400.

In the description of the present invention, an example in which the images forming a 3-D image are the left image and the right image has been described, but not limited thereto. The present invention may also be applied to other 3-D image formats (e.g., side-by-side or top-bottom).

According to the present invention, when the frames of left and right images forming a stereoscopic image are not synchronized with each other, synchronization can be automatically performed. Accordingly, an accurate stereoscopic effect for a stereoscopic image can be guaranteed, and problems, such as that visibility chiefly problematic when viewing a stereoscopic image is degraded or that a feeling of fatigue in eyes, can be solved.

In a conventional synchronization correction method, a person checks and corrects synchronization between left and right image frames by directly checking with eyes. According to the present invention, automated software or an automated hardware apparatus calculates a temporal difference between left and right image frames and performs correction if necessary. Accordingly, conventional inconvenience can be solved. Furthermore, if the automated software or the automated hardware apparatus is fabricated as a chip and mounted on 3-D TV, a 3-D projector, a 3-D camera, a multiplexer/demultiplexer, a codec, and a 3-D terminal, a satisfactory feeling of stereoscopy can be represented when a stereoscopic image is viewed. The software module may be applied to an edition tool, a stereoscopic video player, etc. in order to help the edition and play of a stereoscopic image.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A three dimensional (3-D) image synchronization method, comprising:
determining a reference region for each of frames of a first image and determining a counter region for each of frames of a second image, corresponding to the reference region, for the first image and the second image forming a 3-D image;
calculating feature values of the reference region and the counter region;
extracting a frame difference between the first image and the second image based on the feature values; and
moving any one of the first image and the second image in a time domain based on the extracted frame difference,
wherein extracting the frame difference comprises detecting a frame of the second image, having a feature value most similar to each of the frames of the first image, by comparing a feature value of the reference region and a feature value of the counter region.

2. The 3-D image synchronization method of claim 1, wherein the feature values include a motion vector value for the reference region or the counter region.

3. The 3-D image synchronization method of claim 1, wherein:
the first image is one of a left image and a right image which form the 3-D image, and
the second image is the other of the left image and the right image.

4. The 3-D image synchronization method of claim 1, wherein the feature values comprise luminance or chrominance for the reference region or the counter region.

5. The 3-D image synchronization method of claim 1, wherein each of the reference region and the counter region includes M pixels in a horizontal axis and N pixels in a vertical axis forming each block, from among a plurality of pixels forming a frame (M and N are natural numbers).

6. The 3-D image synchronization method of claim 1, wherein the frame difference is information indicating a number of frames in which the first image and the second image are temporally deviated from each other.

7. The 3-D image synchronization method of claim 1, further comprising:
receiving a first image stream and a second image stream; and
generating the first image and the second image by decoding the first image stream and the second image stream.

8. The 3-D image synchronization method of claim 1, wherein moving any one of the first image and the second image in a time domain based on the extracted frame difference comprises:
receiving an external request signal; and
moving any one of the first image and the second image in the time domain in response to the request signal.

9. The 3-D image synchronization method of claim 1, wherein moving any one of the first image and the second image in a time domain based on the extracted frame difference is performed using a frame difference transmitted by an encoder.

10. A three dimensional (3-D) image synchronization apparatus, comprising:
a matching region determination unit for determining a reference region for each of frames of a first image and determining a counter region for each of frames of a second image, corresponding to the reference region, for the first image and the second image forming a 3-D image;
a feature value calculation unit for receiving information about the reference region and the counter region from the matching region determination unit and calculating feature values of the reference region and the counter region;
a frame difference extraction unit for extracting a frame difference between the first image and the second image based on the feature values; and
a synchronization unit for moving any one of the first image and the second image in a time domain based on the extracted frame difference,
wherein the frame difference extraction unit detects a frame of the second image, having a feature value most similar to each of the frames of the first image, by comparing a feature value of the reference region and a feature value of the counter region.

11. The 3-D image synchronization apparatus of claim 10, wherein the feature values include a motion vector value for the reference region or the counter region.

12. The 3-D image synchronization apparatus of claim 10, wherein:
the first image is one of a left image and a right image which form the 3-D image, and
the second image is the other of the left image and the right image.

13. The 3-D image synchronization apparatus of claim 10, wherein each of the reference region and the counter region includes M pixels in a horizontal axis and N pixels in a vertical axis forming each block, from among a plurality of pixels forming a frame (M and N are natural numbers).

14. The 3-D image synchronization apparatus of claim 10, wherein the feature values comprise luminance or chrominance for the reference region or the counter region.

15. The 3-D image synchronization apparatus of claim 10, wherein the frame difference is information indicating a number of frames in which the first image and the second image are temporally deviated from each other.

16. The 3-D image synchronization apparatus of claim 10, further comprising a decoding unit for receiving a first image stream and a second image stream and generating the first image and the second image by decoding the first image stream and the second image stream.

17. The 3-D image synchronization apparatus of claim 10, further comprising a display for receiving image streams from the synchronization unit and outputting the 3-D image.
